(19) United States
(12) Patent Application Publication
(10) Pub. No.: US 2008/0022387 A1
(43) Pub. Date: Jan. 24, 2008

(54) Firewall penetrating terminal system and method

(76) Inventor: Kwok-Yan Leung, Willowdale (CA)

Correspondence Address: BIRCH STEWART KOLASCH & BIRCH, PO BOX 747, FALLS CHURCH, VA, 22040-0747, US

(21) Appl. No.: 11/473,263

(22) Filed: Jun. 23, 2006

(51) Int. Cl. G06F 15/16

(52) U.S. Cl. 726/12

(57) ABSTRACT

A firewall penetrating terminal system and a method are disclosed herein. In this system, in addition to a terminal and a computer device at the controlled end, an additional firewall device is provided for protecting the computer device. In order that the terminal system may still be utilized in a mechanism having the firewall, the firewall device has undergone some slight modifications, so that the terminal is allowed to penetrate a firewall mechanism and perform remote control and operation of the computer device, only after verifying that the identification data of the terminal is correct and legal.

### BACKGROUND OF THE INVENTION

1. Field of the Invention

The present invention relates to a terminal system and a method, and in particular to a firewall penetrating terminal system and a method.

2. The Prior Arts

In recent years, with the global development and expansion of the enterprises, the strategic planning and design of the corporate information framework is essential to the growth and development of corporate information operations. However, in the implementation of remote information applications between/among corporate subsidiaries, the distributed information structure usually has the following problems and shortcomings:
(1) insufficient information security;
(2) high demand for wideband and inferior system performance;
(3) lack of system expansion flexibility; and
(4) high maintenance cost at user end, such as software dispatch, front end user service.

Due to the afore-mentioned drawbacks and shortcomings of the distributed information framework, thus the centralized information application structure (namely the terminal system) is presently again preferred by and getting the attention of most of the enterprises.

However, with the increasing popularization of the firewall mechanism utilized in a network system for security purpose, the firewall mechanism has become an obstacle in the application of the terminal system. The reason for this is that the terminal of the terminal system lacks the network communication capability (for example, it lacks the IP address of the computer device) and the operation executing capability, so that the conventional terminals are not capable of providing sufficient information for identification purpose, so that the firewall device is not able to identify if the terminal is its legal user. To the firewall mechanism of higher level, the terminal is not able to pass the verification of the firewall mechanism for lacking sufficient operation processing capability.

### SUMMARY OF THE INVENTION

In view of the shortcomings and drawbacks of the prior art, the objective of the present invention is to provide a firewall penetrating terminal system and method, which is used to allow the terminal to penetrate a firewall mechanism and perform remote control and operation of the computer device, only after verifying that the identification data (such as the MAC address) of the terminal is correct and legal.

To achieve the above-mentioned objective, the present invention provides a firewall penetrating terminal system. Wherein, in addition to a terminal and a computer device at the controlled end, an additional firewall device is provided for protecting the computer device. In order that the terminal system may still be used in a mechanism having the firewall, the firewall device has undergone slight modifications, so that the terminal is allowed to penetrate a firewall mechanism and perform remote control and operation of the computer device, only after verifying that the identification data of the terminal is correct and legal.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1A is a schematic diagram of a firewall penetrating terminal system according to a first embodiment of the present invention;

FIG. 1B is a schematic diagram of a firewall penetrating terminal system according to a second embodiment of the present invention; and

FIG. 2 is a schematic diagram of a correspondence table indicating the number of the communication port vs. the IP address of the computer device according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

In the following illustrations, the firewall penetrating terminal system and the method of the present invention will be described in detail with reference to the attached drawings.

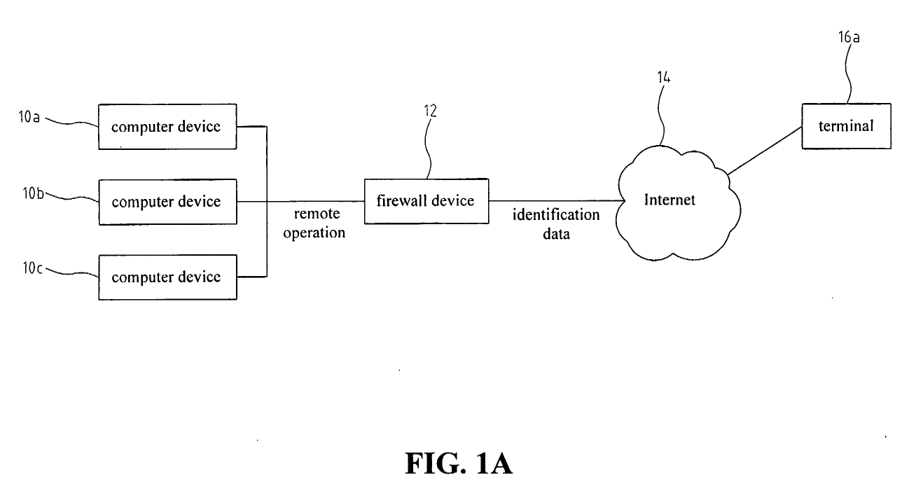

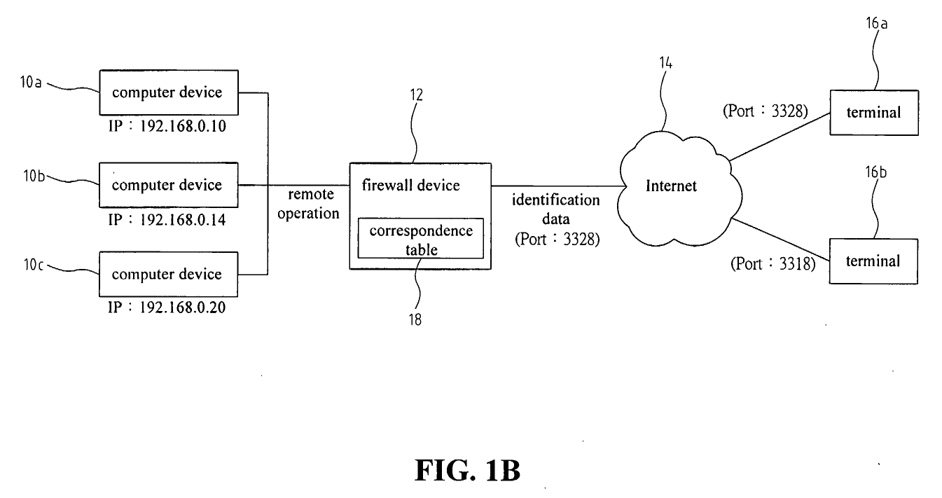

Firstly, referring to FIGS. 1A and 1B. FIG. 1A is a schematic diagram of a firewall penetrating terminal system according to a first embodiment of the present invention. FIG. 1B is a schematic diagram of a firewall penetrating terminal system according to a second embodiment of the present invention. As shown in FIG. 1A, in addition to a terminal 16a and computer devices 10a-10c at the controlled end, an additional firewall device 12 is provided for protecting the computer devices 10a-10c. The terminal 16a used for data entry may be provided with a fundamental network communication and data processing capabilities, yet it has at least to be provided with the operation device (such as keyboard and mouse), and display screen; while the computer devices 10a-10c are capable of accepting the data entry of terminal 16a, and executing the subsequent operations as required (for example opening a file).

In brief, in order that the terminal system may still be utilized in such a mechanism having a firewall, the firewall device 12 of the present invention has undergone some slight modifications, so that only after verifying that the identification data of the terminal 16a is correct and legal, then the terminal 16a is allowed to penetrate a firewall mechanism and perform remote control and operation of one of the computer devices 10a-10c. In other words, in order to verify continuously all the packets coming from Internet 14, thus the instructions transmitted and the packets displayed between terminal 16a and one of the computer devices 10a-10c that is allowed to be accessed in advance must be transferred through the firewall device 12. Though, it is quite often that the packets transfer is conducted through a specific server device, however, in the present invention, this kind of technology is applied to the terminal system. Since it may indeed be utilized to solve the problem of prior art that the terminal system can not be incorporated and utilized in the firewall mechanism, thus the present invention does indeed in conformity with the spirit of an applied invention.

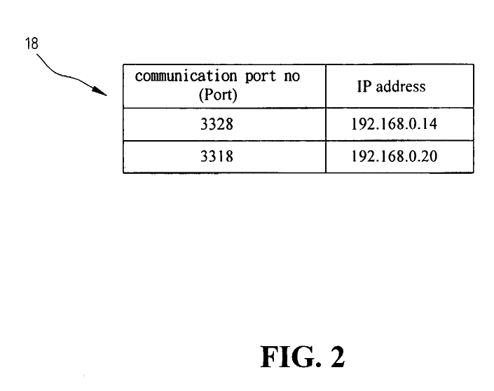

Secondly, referring to FIG. 1B for a schematic diagram of a firewall penetrating terminal system according to a second embodiment of the present invention. As shown in FIG. 1B, in this case a plurality of terminals 16a and 16b are utilized to access a plurality of computer devices 10a-10c, in this condition, since the firewall device 12 is in no way of knowing the packets received belong to which terminal, as such, in this condition, the firewall device is in no way of determining which terminal is allowed to access which computer device. Therefore, the firewall device 12 must be able to analyze and verify that the packets received are transmitted through which communication port according to a correspondence table 18 (as shown in FIG. 2). Thus, in this corresponding table, each entry of data must include at least a communication port number, and in addition, an IP address of a corresponding computer device.

For example, in case that terminal 16a is required to access the computer device 10, then terminal 16a is required to send its identification data (such as a device ID code, or an MAC address of an affiliated network card). In addition, since the request for the firewall device 12 to make the pertinent connection to the computer device is sent by terminal 16a, therefore all the packets sent by terminal 16a must be transferred through the communication port 3328. Upon receiving the packets transmitted through the communication port 3328 for the purpose of opening a specific directory in the computer device 10b, the firewall device is capable of determining from the correspondence table 18 as shown in FIG. 2 that the packets are sent from terminal 16a, and the destination of the packets is the computer device 16b. Upon completing the remote control and operation as requested by the related terminal by means of the computer device 16b (for example opening a directory), the related display packets must be transmitted back to terminal 16a through firewall device 12, so that the user may view the contents of the directory on the display screen.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. A firewall penetrating terminal system, comprising:
a terminal, having identification data used for identification, and being capable of being used to remote control and operate a computer device; and
a firewall device, used to allow said terminal to penetrate the firewall mechanism and perform the remote control and operation of said computer device, after verifying that said identification data are correct and legal.

2. The firewall penetrating terminal system as claimed in claim 1, wherein said identification data is a device ID code of said terminal, or an MAC address of its affiliated network card.

3. The firewall penetrating terminal system as claimed in claim 1, wherein the instructions of remote control and operation are transmitted to said computer device via said firewall device, and the results are reported back to said terminal via said firewall device after the completion of processing by said computer device.

4. The firewall penetrating terminal system as claimed in claim 1, wherein in case that a plurality of said terminals are utilized, they are capable of being distinguished by the said firewall device by making use of the communication port number used by the respective terminal in the communication.

5. The firewall penetrating terminal system as claimed in claim 1, wherein said firewall device further includes a correspondence table, in which each data entry contains at least a communication port number and the IP address of said corresponding computer device.

6. A firewall penetrating terminal utilization method, comprising the steps of:
providing a terminal having identification data used for identification, wherein said terminal is used to remote control and operate a computer device; and
allowing said terminal to penetrate said firewall mechanism and remote control or operate said computer device, after verifying that said identification data are correct and legal.

7. The firewall penetrating terminal utilization method as claimed in claim 6, wherein said identification data is a device ID code of said terminal, or an MAC address of its affiliated network card.

8. The firewall penetrating terminal utilization method as claimed in claim 6, wherein the instructions of remote control and operation are transmitted to said computer device via said firewall device, and the results are reported back to said terminal via said firewall device after the completion of processing by said computer device.
